(19) United States
(12) Patent Application Publication
(10) Pub. No.: US 2006/0179696 A1
(43) Pub. Date: Aug. 17, 2006

(54) Bracelet

(76) Inventor: Colleen M. Hayes, Oakland, NE (US)

Correspondence Address: JAMES RAY & ASSOCIATES, 2640 PITCAIRN ROAD, MONROEVILLE, PA, 15146, US

(21) Appl. No.: 11/339,889

(22) Filed: Jan. 26, 2006

Related U.S. Application Data
(60) Provisional application No. 60/650,815, filed on Feb. 8, 2005.

(51) Int. Cl. G09F 21/02

(52) U.S. Cl. 40/586

(57) ABSTRACT

A device for alerting individuals of a person's inability to communicate normally due to at least one of deafness and speech problems. The device comprises an emergency emblem for alerting individuals that this person is incapable of communicating normally and a preselected object having the emergency emblem disposed thereon. There is a means engageable with the preselected object for at least one of wearing and hanging such device on such person.

### CROSS REFERENCE TO RELATED APPLICATIONS

This application is closely related to and claims benefit from U.S. Provisional Application Ser. No. 60/650,815 filed Feb. 8, 2005.

### FIELD OF THE INVENTION

The present invention relates, in general, to a jewelry item such as bracelet, and, more specifically the present invention relates to such bracelet with an emblem displayed on it which will notify the public that the wearer is unable to communicate accurately due to inability to speak or hear.

### BACKGROUND OF THE INVENTION

There are a variety of emergency devices which are available to the public that can be worn or carried by an individual so as to indicate that the wearer has a problem. Many have a medical alert symbol on them. These are worn or carried by persons with heart problems, diabetes or are taking blood thinners or a variety of problems.

However, little has been done for persons who are hearing impaired, are mute or have difficulty in communicating. Thus, it would be advantageous for such persons if there were some means to alert others that the wearer has such a problem.

### SUMMARY OF THE INVENTION

Thus, the present invention provides a device for alerting individuals of a person's inability to communicate normally due to at least one of deafness and speech problems. The device comprises an emergency emblem for alerting individuals that this person is incapable of communicating normally and a preselected object having the emergency emblem disposed thereon. There is a means engageable with the preselected object for at least one of wearing and hanging such device on such person.

### OBJECTS OF THE INVENTION

It is, therefore, one of the primary objects of the present invention to provide an emergency emblem which can notify the public that such wearer is unable to communicate normally.

Another object of the present invention is to provide an emergency emblem which can be displayed as a pin, pendant, bracelet, belt buckle or necklace.

Still another object of the present invention is to provide an emergency emblem which has an embedded microchip or an engraving to provide information.

Yet another object of the present invention is to provide a an emergency emblem which can be a mouth and/or an ear located in a black circle with a slash across the image.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a plan view of emergency emblem for a mute person.

FIG. 2 is a plan view of emergency emblem for a deaf person.

FIG. 3 is a partial perspective view of a bracelet showing an emergency emblem for a deaf person.

FIG. 4 is a partial perspective view of a pin showing an emergency emblem for a mute person having a microchip disposed therein for providing information.

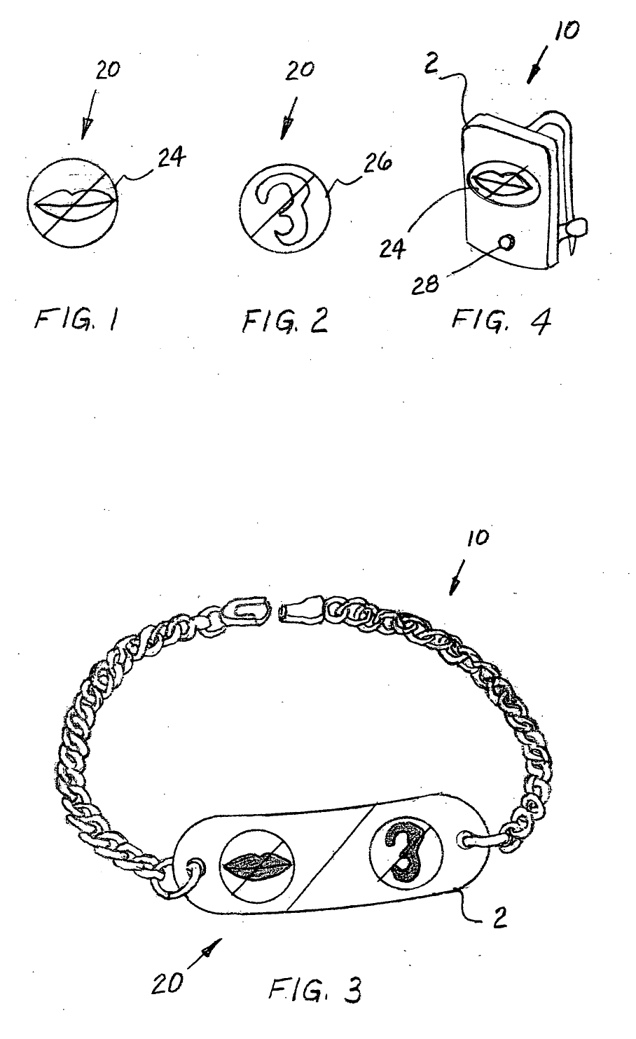

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides an apparatus, generally designated 10, for displaying a preselected identification means for use on preselected objects for alerting individuals of a person's inability to communicate normally due to at least one of deafness and speech problems. While most people are able to easily identify themselves and ask for help, options for the deaf and mute individuals are very limited. If a deaf or mute person falls ill in public, they can find themselves incapable of providing emergency information and even alerting anyone that they are incapable of communicating normally.

The device 10 comprises a preselected object 2 for use by an impaired individual and an emergency emblem, generally designated 20, disposed on such preselected object 2 for alerting individuals that a wearer of such preselected object 2 is incapable of communicating normally.

It is generally preferred that such preselected object 2 be worn where it would be normally visible. Such preselected object 2 is selected from one of a belt buckle, pin, pendant, bracelet and necklace. Any such item could be used; however, as stated previously it is preferred that such preselected object be visible so that if a person is wearing a sweater the pin on the outside of the sweater would be instantly visible. Generally a bracelet is visible unless it would be completely covered by long sleeves, however, such an item like a bracelet is a preferred object for displaying such emergency emblem 20.

Such emergency emblem 20 is one of a mouth 24 and an ear 26 located in a circle with a slash across one of such mouth 24 and such ear 26. This emergency emblem 20 would instantly alert anyone seeing it that the person is either deaf or mute.

It is also an embodiment of the invention that such device 10 include an imbedded microchip 32 for providing emergency personnel with contact information regarding an individual wearing the device. Such device could also include engraving on the device for providing emergency personnel with contact information regarding the individual wearing the device. Thus, not only would emergency personnel be alerted that the individual cannot communicate normally but such emergency personnel would also have a contact person with a phone numbers so as to be able report a problem and also receive more information about such individual wearing the device. Thus, the device would not only save time but could potentially save a person's life or at least insure that treatment for such individual would be appropriate.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. A device for alerting individuals of a person's inability to communicate normally due to at least one of deafness and speech problems, said device comprising:
(a) an emergency emblem for alerting individuals that this person is incapable of communicating normally;
(b) a preselected object having said emergency emblem disposed thereon; and
(c) a means engageable with said preselected object for at least one of wearing and hanging said device on such person.

2. The device, according to claim 1, wherein said emergency emblem is normally visible.

3. The device, according to claim 2, wherein said preselected object is selected from one of a belt buckle, pin, pendant, bracelet and necklace.

4. The device, according to claim 3, wherein said preselected object is a bracelet.

5. The device, according to claim 1, wherein said emergency emblem is at least one of a mouth and an ear located in a circle with a slash across said at least one of said mouth and said ear.

6. The device, according to claim 4, wherein said emergency emblem includes both said mouth and said ear located in said circle with said slash across said mouth and said ear.

7. The device, according to claim 1, wherein said device further includes a means for providing emergency personnel with contact information.

8. The device, according to claim 7, wherein said means includes an imbedded microchip for providing emergency personnel with contact information regarding an individual wearing said device.

9. The device, according to claim 7, wherein said means further includes engraving on said device for providing emergency personnel with contact information regarding an individual wearing said device.

10. The device, according to claim 1, wherein said means engageable with said preselected object includes pins, chain, belt, and expansion band.
